(19) United States
(12) Patent Application Publication
(10) Pub. No.: US 2007/0192107 A1
(43) Pub. Date: Aug. 16, 2007

(54) Self-improving approximator in media editing method and apparatus

(76) Inventors: Leonard Sitomer, Wellesley, MA (US); Stephen J. Reber, Brookline, NH (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/652,368

(22) Filed: Jan. 10, 2007

Related U.S. Application Data
(60) Provisional application No. 60/758,114, filed on Jan. 10, 2006.

(51) Int. Cl. G10L 21/00; G06F 17/00; G06F 3/00

(52) U.S. Cl. 704/270; 715/500.1; 715/716

(57) ABSTRACT

A self-improving approximator for use in media editing is disclosed. The approximator estimates location in the media file/video data domain of a user-selected word or text unit in the text script transcription of the corresponding audio of the video data. During editing, the approximator calculates and displays the estimated time location of user-selected text to assist the user-editor in cross referencing between the beginning and ending of user-selected passage statements in the text script and the corresponding video/media data in a rough cut or subsequent media work. The approximator enables simultaneous editing of text and video/media by the selection of either source component. The approximator self improves its accuracy based on differentials calculated between tracked user adjustments to media-text associations and initial approximations (estimates).

### RELATED APPLICATION

This application claims the benefit of U.S. Provisional Application No. 60/758,114, filed on Jan. 10, 2006. The entire teachings of the above application are incorporated herein by reference.

### BACKGROUND OF THE INVENTION

Early stages of the video production process include obtaining interview footage and generating a first draft of edited video. Making a rough cut, or first draft, is a necessary phase in productions that include interview material. It is usually constructed without additional graphics or video imagery and used solely for its ability to create and coherently tell a story. It is one of the most critical steps in the entire production process and also one of the most difficult. It is common for a media producer to manage 25, 50, 100 or as many as 200 hours of source tape to complete a rough cut for a one hour program.

Current methods for developing a rough cut are fragmented and inefficient. Some producers work with transcripts of interviews, word process a script, and then perform a media edit. Others simply move their source footage directly into their editing systems where they view the entire interview in real time, choose their set of possible interview segments, then edit down to a rough cut.

Once a rough cut is completed, it is typically distributed to executive producers or corporate clients for review. Revisions requested at this time involve more media editing and more text editing. These revision cycles are very costly, time consuming and sometimes threaten project viability.

### SUMMARY OF THE INVENTION

Generally, the present invention addresses the problems of the prior art by providing a computer automated method and apparatus of video or other media editing. In particular, the present invention provides a self improving, time approximation for text location. With such self improving time approximation, features for enhancing media editing and especially editing of a rough cut are enabled.

In one embodiment, a first draft or rough cut is produced by media editing method and apparatus as follows. A transcription module receives subject video data. Data of other media instead of video data is also suitable. The subject video/media data includes corresponding audio data. The transcription module generates a working transcript of the corresponding audio data of the subject video/media data and associates portions of the transcript to respective corresponding portions of the subject video/media data. A host computer provides display of the working transcript to a user and effectively enables user selection of portions of the subject video/media data through the displayed transcript. An assembly member responds to user selection of transcript portions of the displayed transcript and obtains the respective corresponding video/media data portions. For each user selected transcript portion, the assembly member, in real time, (a) obtains the respective corresponding video/media data portion, (b) combines the obtained video/media data portions to form a resulting work, and (c) displays a text script of the resulting work. It is this resulting work that is the “rough cut”. The resulting work may be video, multimedia or the like (generally referenced ‘media’ hereafter).

The host computer provides display of the rough cut (resulting media work) and corresponding text script to the user for purposes of further editing. Preferably, the resulting text script and rough cut are simultaneously (e.g., side by side) displayed. The display of the rough cut is supported by the initial video/media data or a media file thereof. The displayed corresponding text script is formed of a series of passages. Further, each passage includes one or more statements. The user may further edit the rough cut by selecting a subset of the statements in a passage. The media editing apparatus enables a user to redefine (split or otherwise divide) passages.

In response to user selection of a subset of the passage statements, the present invention estimates the corresponding time location (e.g., frame, hour, minutes, seconds of elapsed time) in the media file (initial video data) of the beginning and ending of the user-selected passage statements. In a preferred embodiment, the present invention provides a bi-directional means for synchronizing (associating) time locations in the video/media data or media file domain and corresponding locations within a text passage (a term or other text unit) in the text script. The user can select a location in or a segment of the media file/media data to determine a corresponding location or text passage within the text script, or, in the opposite direction, the user can select a location or text passage in the text script to determine a position in or segment of the media file/media data. During editing activity, where script text and a media rough cut are being developed by the user simultaneously, the present invention approximator enables the user to choose and act upon either the media file/media data or the text passage in the text script and in response calculates and displays the estimated correspondence between subject text passages and corresponding segments of media data in the rough cut.

Further, the invention system allows the user to make adjustments by moving a position in the media file relative to the script text and/or by moving a position in the text passage relative to its corresponding segment of the media file. In a preferred embodiment, the invention system tracks these adjustments and calculates differentials between the tracked user adjustments and initial estimations/approximations. The system uses these differentials to automatically adjust speaker profiles and profiles of the media file/data. As a result, the invention approximator self improves its precision.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic view of a computer network environment in which embodiments of the present invention may be practiced.

FIG. 2 is a block diagram of a computer from one of the nodes of the network of FIG. 1.

FIG. 3 is a flow diagram of media editing method and system utilizing an embodiment of the present invention.

FIGS. 4a-4c are schematic views of time approximation for text location in one embodiment of the present invention.

FIG. 5 is a schematic illustration of a graphical user interface in one embodiment of the present invention.

FIG. 6 is a flow diagram of the self improving approximation of the embodiment of FIG. 4.

### DETAILED DESCRIPTION OF THE INVENTION

A description of example embodiments of the invention follows.

The present invention provides a media/video time approximation for text location in a transcript of the audio in a video or multimedia work. More specifically, one of the uses of the invention media time location technique is for editing video by text selections and for editing text by video/media selections.

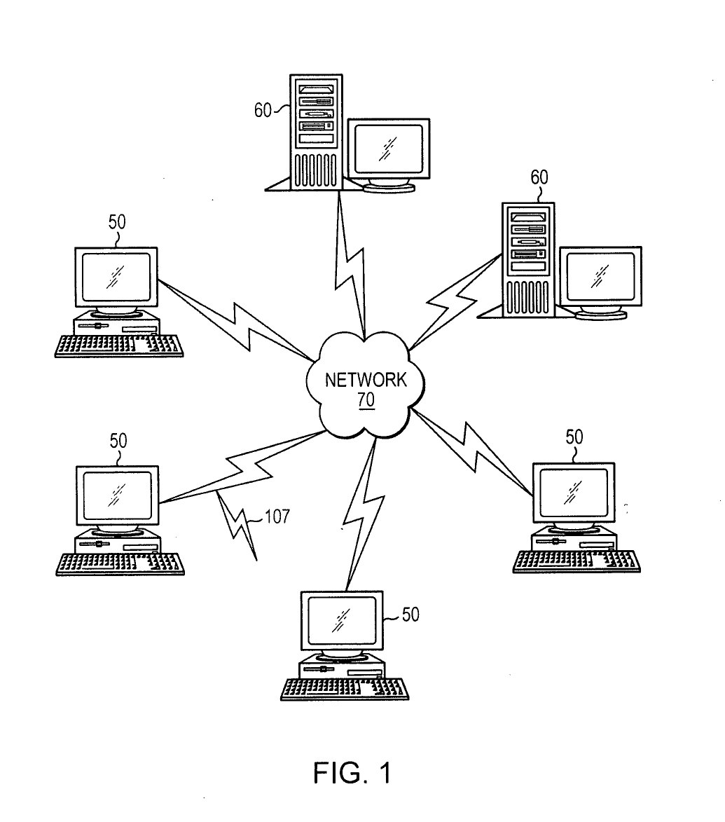

FIG. 1 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

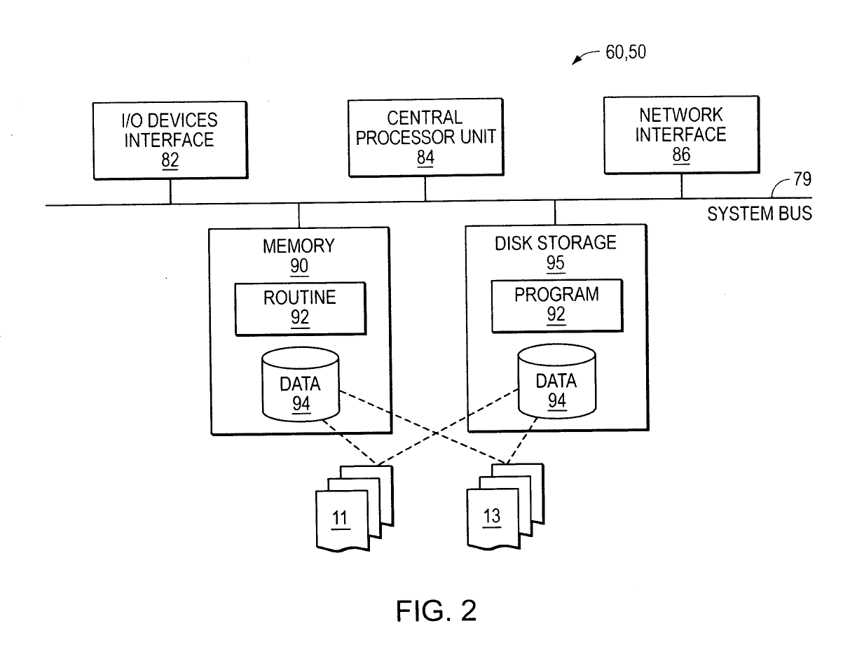

FIG. 2 is a diagram of the internal structure of a computer (e.g., client processor/device 50 or server computers 60) in the computer system of FIG. 1. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 1). Memory 90 provides volatile storage for computer software instructions used to implement an embodiment of the present invention (e.g., Program Routines 92 and Data 94, detailed later). Disk storage 95 provides non-volatile storage for computer software instructions 92 and data 94 used to implement an embodiment of the present invention. Central processor unit 84 is also attached to system bus 79 and provides for the execution of computer instructions.

As will be made clear later, data 94 includes source video/media data files (or media files) 11 and corresponding working transcript files 13 (and related text script files 17). Working transcript files 13 are text transcriptions of the audio tracks of the respective video data 11.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

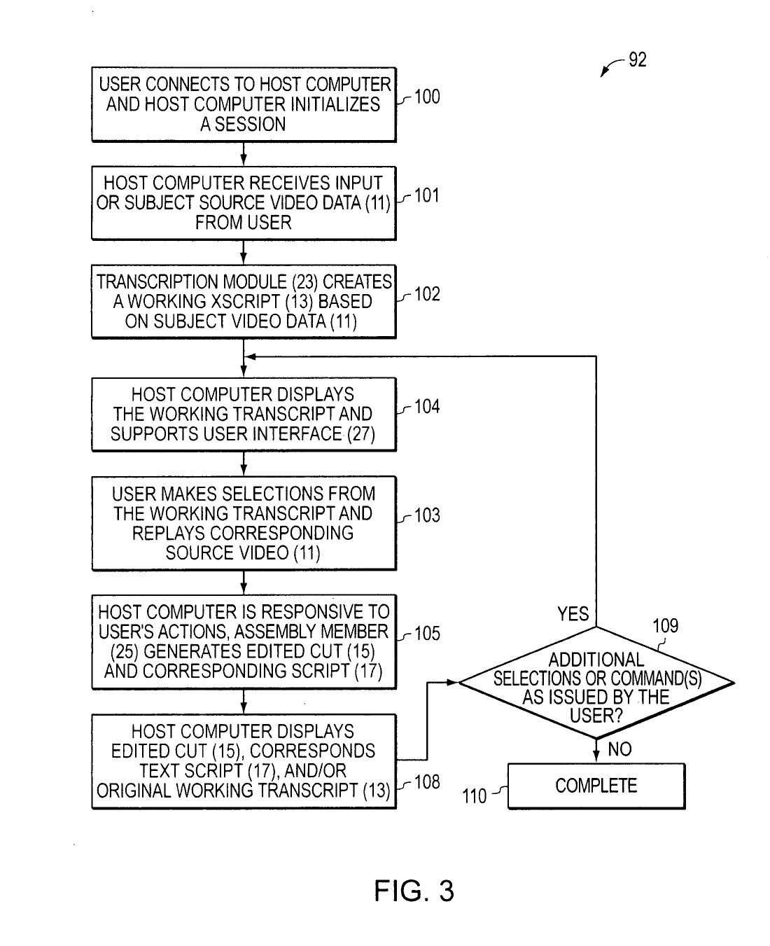

In one embodiment, a host server computer 60 provides a portal (services and means) for video editing and routine 92 implements the invention video editing system. Users (client computers 50) access the invention video editing portal through a global computer network 70, such as the Internet. Program 92 is preferably executed by the host 60 and is a user interactive routine that enables users (through client computers 50) to edit their desired video data. FIG. 3 illustrates one such program 92 for video editing services and means in a global computer network 70 environment.

At an initial step 100, the user via a user computer 50 connects to invention portal at host computer 60. Upon connection, host computer 60 initializes a session, verifies identity of the user and the like.

Next (step 101) host computer 60 receives input or subject media data 11 transmitted (uploaded or otherwise provided) upon user command. The subject media data 11 includes corresponding audio data, multimedia and the like and may be stored in a media file. In response (step 102), host computer 60 employs a transcription module 23 that transcribes the corresponding audio data of the received video data (media file) 11 and produces a working transcript 13. Speech-to-text technology common in the art is employed in generating the working transcript from the received audio data. The working transcript 13 thus provides text of the audio corresponding to the subject (source) video/media data 11. Further the transcription module 23 generates respective associations between portions of the working transcript 13 and respective corresponding portions of the subject media data (media file) 11. The generated associations may be implemented as links, pointers, references or other loose data coupling techniques. In preferred embodiments, transcription module 23 inserts time stamps (codes) 33 for each portion of the working transcript 13 corresponding to the source media track, frame and elapsed time of the respective portion of subject video/media data 11.

Host computer 60 displays (step 104) the working transcript 13 to the user through user computers 50 and supports a user interface 27 thereof. In step 103, the user interface 27 enables the user to navigate through the displayed working transcript 13 and to select desired portions of the audio text (working transcript). The user interface 27 also enables the user to play-back portions of the source video data 11 as selected through (and viewed along side with) the corresponding portions of the working transcript 13. This provides audio-visual sampling and simultaneous transcript 13 viewing that assists the user in determining what portions of the original media data 11 to cut or use. Host computer 60 is responsive (step 105) to each user selection and command and obtains the corresponding portions of subject media data 11. That is, from a user selected portion of the displayed working transcript 13, host computer assembly member 25 utilizes the prior generated associations (from step 102) and determines the portion of original video data 11 that corresponds to the user selected audio text (working transcript 13 portion).

The user also indicates order or sequence of the selected transcript portions in step 105 and hence orders corresponding portions of subject media data 11. The assembly member 25 orders and appends or otherwise combines all such determined portions of subject media data 11 corresponding to user selected portions and ordering of the displayed working transcript 13. An edited version (known in the art as a “rough cut”) 15 of the subject starting media data and corresponding text script 17 of the rough cut results.

Host computer 60 displays (plays back) the resulting video work (edited version or rough cut) 15 and corresponding text script 17 to the user (step 108) through user computers 50. Preferably, host computer 60, under user command, simultaneously displays the original working transcript 13 with the resulting medoa work/edited (cut) version 15. In this way, the user can view the original audio text and determine if further editing (i.e., other or different portions of the subject media data 11 or a different ordering of portions) is desired. If so, steps 103, 104, 105 and 108 as described above are repeated (step 109). Otherwise, the process is completed at step 110.

Given the rough or edited cut 15, the present invention provides an audio-video transcript based media editing process using display of the corresponding text script 17 and optionally the working transcript 13 of the audio corresponding to subject source video data 11. Further, the assembly member 25 generates the rough cut and succeeding versions 15 (and respective text scripts 17) in real time of the user selecting and ordering (sequencing) corresponding working transcript 13/text script 17 portions. To assist the user in editing the rough cut 15, the present invention (host computer 60, program 92) estimates the time location (e.g., frame, hour, minutes, seconds of elapsed time) in the media data 11 of a word or other text unit in the text script 17 upon user selection of the word. The present invention calculates media times for beginning and ending for a given text location or text passage and calculates text position or a portion of a text passage from a given location or beginning and ending of a segment of media data/media file. Furthermore, during user editing activity (throughout steps 103, 104, 105 and 108), the invention displays position markers to provide a visual cross-reference between the beginning and ending of user-selected portions in the text script 17 and the corresponding video-audio segment in the media file/source media data 11.

In one embodiment, a bar indicator 75 graphically illustrates the portion of media data, relative to the whole media data 11, that corresponds to the user selected text portions 39. The estimated time locations are displayed with an estimated beginning time associated with one end of the bar indicator 75 and an estimated ending time associated with the other end of the bar indicator 75. FIG. 5 is illustrative.

Preferably, the bar graphical interface operates in both directions. That is, upon a user operating (dragging/sliding) the bar indicator 75 to specify a desired portion of the media data 11, the present invention (host computer 60, program 92) highlights or otherwise indicates the corresponding resulting text script 17. Upon a user selecting text portions 39 in the working text script 17, the present invention augments (moves and resizes) the bar indicator 75 to correspond to the user selected text portions 39.

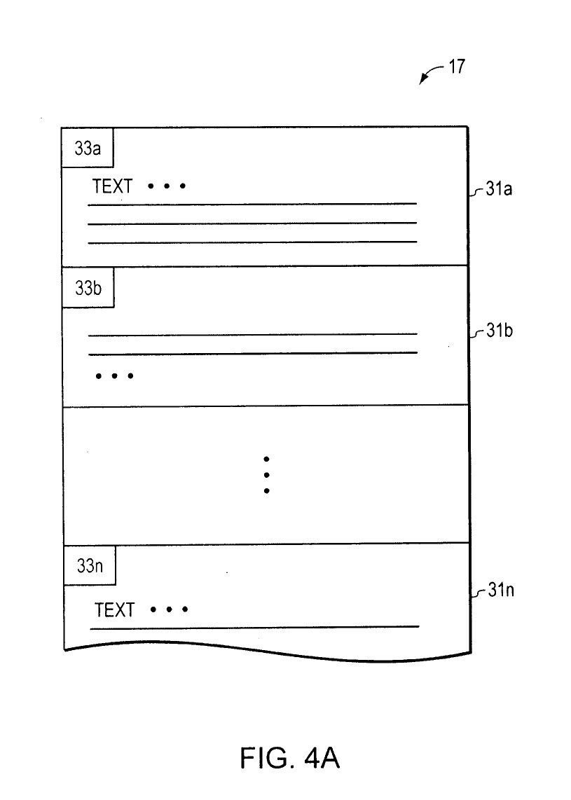

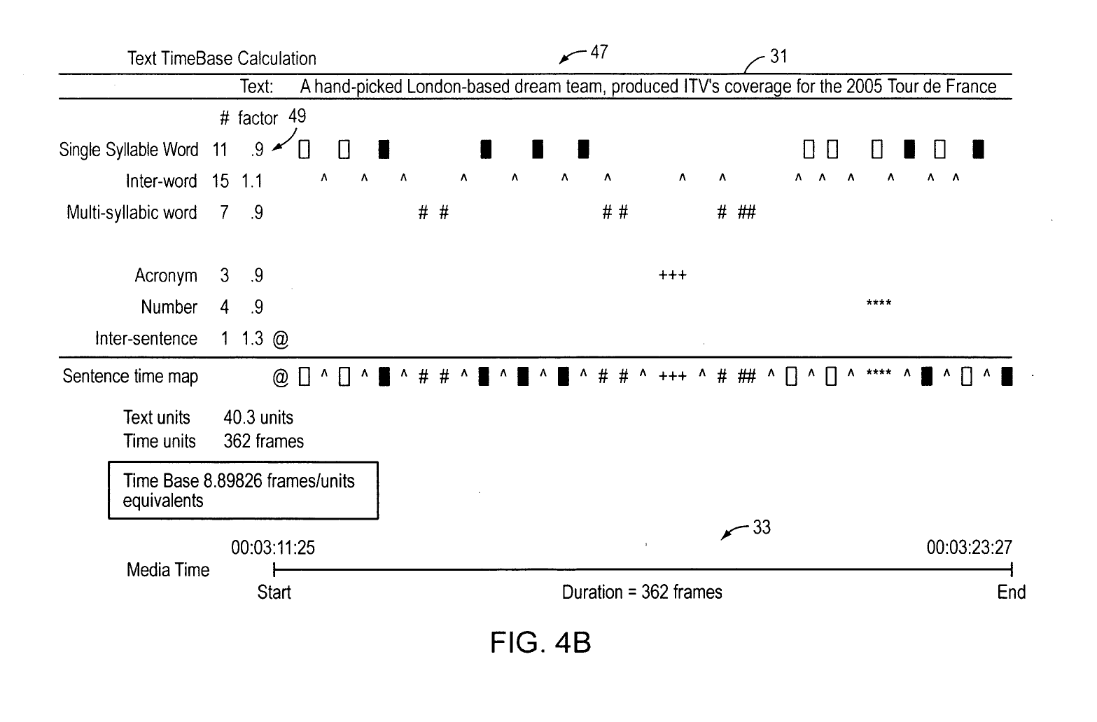

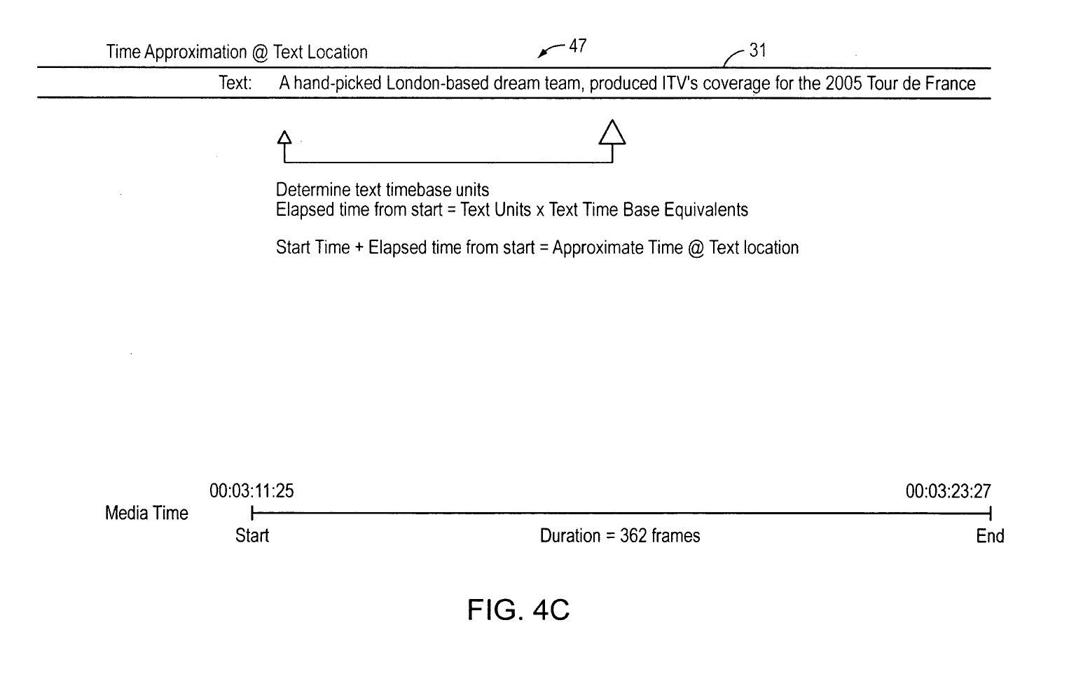

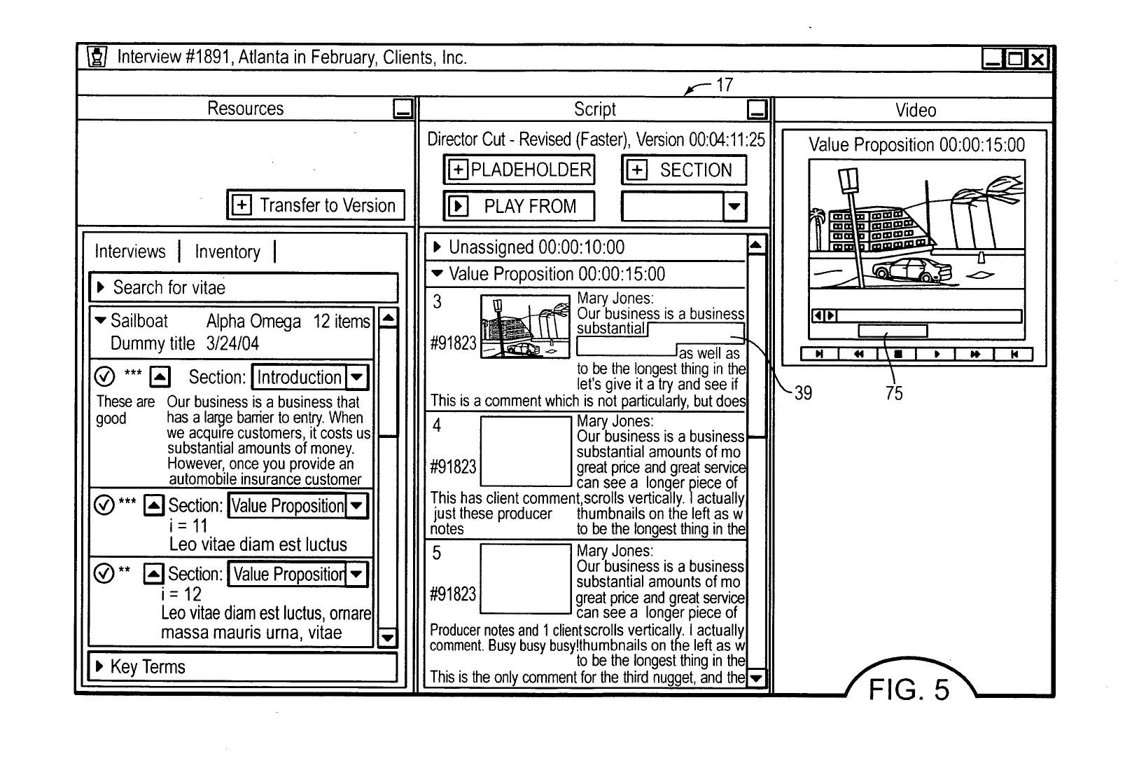

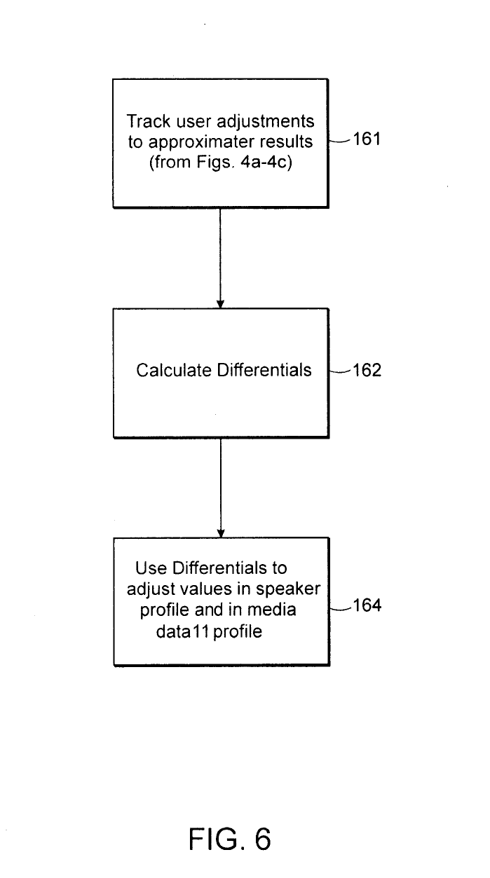

The foregoing is accomplished by the present invention generating and effecting a mapping between words (units) and sentence units of the text script 17 and time locations in the video/media data (media file) 11. Time approximation (in the media data 11 domain) for a text location in text scripts 17 in a preferred embodiment is illustrated in FIGS. 4a through 4c. A working text script 17 is formed of a series of passages 31 a, b, . . . n. Each passage 31 is represented by a record or similar data structure in system data 94 (FIG. 2) and includes one or more statements of the corresponding videoed interview (footage). Each passage 31 is time stamped (or otherwise time coded) 33 by a start time, end time and/or elapsed time of the original media capture of the interview (footage). Elapsed time or duration of the passage 31 is preferably in units of number of frames.

For a given passage 31 (FIG. 4b), the present invention time approximator 47 counts the number of words, the number of inter-word locations, the number of syllables, the number of acronyms, the number of numbers used (recited) in the passage statements and the number of inter-sentence locations. Acronyms and numbers may be determined based on a dictionary or a database lookup. In one embodiment, the present invention 47 also determines the number of double vowels or employs other methods for identifying number of syllables (as a function of vowels or the like). Each of the above attributes is then multiplied by a respective weight (typically in the range −1 to +2). The resulting products are summed together, and the resulting sum total provides the number of text units for the passage 31.

In other embodiments, various methods may be used to determine syllable count in a subject passage 31. For example, a dictionary lookup table may be employed to cross reference a term (word) in subject passage 31 with the number of syllables therein. Other means and methods for determining a syllable count are suitable.

Next, the present invention approximator 47 defines a Time Base Equivalent (constant C) of passage 31. The time duration (number of frames) 33 of passage 31 is divided by the number of text units calculated above for the passage 31. The resulting quotient is used as the value of the Time Base Equivalent constant C.

In the example illustrated in FIG. 4b the number of single syllable words in passage 31 is 11, the number of inter-words is 15, the number of multi-syllabic words is 7, the number of acronyms is 3, the number of numbers recited in text is 4. There is 1 inter-sentence location. This accounting is shown numerically and graphically in FIG. 4b. A sentence map in FIG. 4b illustrates the graphical accounting in word sequence (sentence) order. Respective weights 49 for each attribute are listed in the column indicating “factor”. In other embodiments, the weight for double vowels is negative to effectively nullify any duplicative accounting of text units. The total number of text units is then calculated for this example as (11×0.9)+(15×1.1)+(7×0.9)+(3×0.9)+(4×0.9)+(1×1.3)=40.3.

Time duration of illustrated passage 31 is 362 frames as shown at 33 in FIG. 4b. Dividing the above calculated 40.3 text units by 362 frames produces a Time Base Equivalent of 8.898 frames/unit (used as constant C below).

The produced Time Base Equivalent constant is then used as follows to calculate the approximate time occurrence (in the source video/media data 11) of a user-selected word in text script 17.
Elapsed time from start=Text Units×C where C is the above defined Time Base Equivalent constant. (Eq. 1)
Start time of passage 31+Elapsed time from start=Approximate Time at text location (Eq. 2)

FIG. 4c is illustrative where the approximate time in media time (video/media data 11 domain) of the term “team” in corresponding text script 17/passage 31 of the example is sought. For each word or linguistic unit from the beginning of passage 31 through the subject term “team”, the present invention approximator 47 counts the number of single syllable words, inter-words, multi-syllabic words, acronyms, numbers, and inter-sentences. For each of these attributes, the determined count is multiplied by the respective weight 49 (given in FIG. 4b), and the sum of these products generates a working text unit. According to Eq. 1, the working text units multiplied by the Time Base Equivalent constant (8.898 detailed above) produces an elapsed time from start. According to Eq. 2, that elapsed time from start is added to the passage 31 start time of 3:11:25 (in the illustrated example) to produce an estimated or approximate time of the subject term “team”.

Likewise, time approximation of a second user selected word at a location spaced apart from the term “team” (e.g., at the end of a desired statement, phrase, subset thereof) in passage 31 may be calculated. In this manner, estimated beginning time and ending time of the user selected passage 31 subset defined between “team” and the second user selected word are produced.

In turn, the present invention displays the computed estimated times of user selected terms (begin time and end time of passage subsets) as described above and illustrated in FIG. 5. Throughout the editing process, the user can interpret elapsed amounts of time per passages 31 based on the displayed estimated times. The association of positions in media files with corresponding text locations in the text script enables the user to edit media files by the selection of either text passages or media segments (locations) or both. Thus, the invention time approximator enables simultaneous editing of text and video/media by the selection of either source component.

Improving Precision of Approximator:

The approximator in one embodiment utilizes variables in its method for calculating relative positions between media file 11 and text locations in text script 17. These variables apply proportional weightings to the counting methods in order to simulate a generalized profile for the spoken language of English. The system applies a generalized set of variable settings as a default to establish a generalized speech profile. The system further provides users the ability to manually adjust these variables to improve the precision of the approximator, by translating aspects of speech style, including hesitating and thoughtfulness, rapid or slow pacing, and increasing or decreasing the variables provided. These new values are stored to build profiles of both the subject speaker and the specific instance media file with that speaker. New values added to the speaker profile improve precision across all files where the speaker is present. New values to the media file profile improve precision to an appearance of the speaker that differs from the speaker's profile.

Self improving precision capability:

During the course of media and script editing activity, the user makes selections from either the transcript text 13, text script 17, or media data/media file 11, and responsively the invention approximator 47 makes corresponding selections in the other domain (media 11 or text 13, 17). Subsequent to that early step in the rough cut making process, the user may make manual adjustments to the initial or intermediate results of the approximator 47 in the process of finalizing the script 17 and rough cut/resulting media work 15. Adjustments include moving a position in the media file/media data 11 relative to the script text 17, or moving a position in the text passage 31 (in text script 17) relative to its corresponding segment of the media file/media data 11. Or both simultaneously.

Preferably, as shown in FIG. 6, the system tracks 161 these adjustments and calculates differentials 162 between the approximator's 47 calculations in FIGS. 4a-c and the user adjustments. At step 164 the system uses these differentials to automatically adjust values in the Speaker's profile and the profile created for the media file/media data 11. As a result, the approximator 47 improves its precision without the user directly adjusting the proportional weighting variables.

While this invention has been particularly shown and described with references to preferred embodiments thereof, it will be understood by those skilled in the art that various changes in form and details may be made therein without departing from the scope of the invention encompassed by the appended claims.

For example, the present invention may be implemented in a client server architecture in a local area or wide area network instead of the global network 70.

In some embodiments, the weights (multipliers) 49 for each attribute in the approximator 47 computations are user-adjustable. The graphical user interface in FIG. 5 may provide “buttons” or other user-selectable means to adjust weight 49 values.

Where reference is made to ‘video’ other media, streaming data and the like are contemplated. The techniques of the present invention are applicable to various data format and kind.

While this invention has been particularly shown and described with references to example embodiments thereof, it will be understood by those skilled in the art that various changes in form and details may be made therein without departing from the scope of the invention encompassed by the appended claims.

What is claimed is:

1. In a media editing system having media data and a text transcript of audio corresponding to the media data, the text transcript being formed of one or more passages, a position approximator comprising:
for each passage in the text transcript, a respective text based equivalent defined for the passage;
a counter member for counting attributes in a subject passage, the counter member counting attributes from a start of the subject passage to a user-selected term in the subject passage; and
a processor routine responsive to user selection of the term in the subject passage, the processor routine calculating an estimated place of occurrence in the media data of the user-selected term as a function of the counted attributes and the text based equivalent of the subject passage.

2. A position approximator as claimed in claim 1 wherein the processor routine calculates the estimated place of occurrence by:
summing the counted attributes in a weighted fashion, said summing producing an intermediate result;
generating a multiplication product of the intermediate result and the text based equivalent of the subject passage; and
using the generated multiplication product as an estimated elapsed time and adding the generated multiplication product to a start time of the subject passage to produce the estimated place of occurrence in the media data of the user-selected term.

3. A position approximator as claimed in claim 2 wherein the processor routine self improves its accuracy by calculating and storing difference between subsequent user adjustment of the estimated place and initially calculated estimated place; and the processor routine stores the calculated differences in profiles of the media data.

4. A position approximator as claimed in claim 1 wherein the attributes include words, syllables, acronyms, numbers, double vowels and/or inter-sentence locations.

5. The position approximator of claim 1, wherein the processor routine is further responsive to subsequent user adjustment of the estimated place such that the processor routine self improves accuracy of its estimates.

6. The position approximator of claim 5, wherein the processor routine calculates a difference between the user adjustment of the estimated place, and uses the calculated difference in subsequent estimates in a manner improving accuracy.

7. A computer system for media editing comprising:
means for receiving subject media data, the subject media data including corresponding audio data;
means for transcribing the corresponding audio data of the subject media data, the transcribing means generating a working transcript of the corresponding audio data and associating portions of the working transcript to respective corresponding portions of the subject media data;
display and user selection means for displaying the working transcript to a user and enabling user selection of portions of the subject media data through the displayed working transcript, the display and user selection means including, for each user selected transcript portion from the displayed working transcript, in real time, (i) obtaining the respective corresponding media data portion, (ii) combining the obtained media data portions to form a resulting media work, (iii) forming a script text corresponding to the resulting media work, and (iv) displaying the resulting media work to the user upon user command during user interaction with the displayed working transcript;
the display and user selection means further displaying the resulting media work and corresponding script text to a user and enabling user selection of portions of the working transcript or script text through the displayed resulting media work, and
an approximation means coupled to the display and user-selection means, the approximation means calculating for display an estimated place of occurrence in the media data of the audio data corresponding to user-selected transcript portion or user-selected script text portion.

8. The computer system of claim 7, wherein the display and user selection means includes for each user selected segment from the displayed resulting media work, in real time, (i) obtaining the respective corresponding portions of the working transcript, (ii) combining the obtained transcript portions to form a resulting text script and (iii) displaying the resulting text script to the user upon user command during user interaction with the displayed resulting media work.

9. The computer system of claim 7, wherein the approximation means calculates the estimated place of occurrence by:
summing the counted attributes in a weighted fashion, said summing producing an intermediate result;
generating a multiplication product of the intermediate result and the text based equivalent of the subject passage; and
using the generated multiplication product as an estimated elapsed time and adding the generated multiplication product to a start time of the subject passage to produce the estimated place of occurrence in the media data of the user-selected term.

10. The computer system of claim 9 wherein the approximator means self improves its accuracy by calculating and storing difference between subsequent user adjustment of the estimated place and initially calculated estimated place; and the processor routine stores the calculated differences in profiles of the media data.

11. A computer-implemented method of editing media, comprising:
transcribing corresponding audio data of a subject media data to produce a working transcript of the audio data;
associating portions of the working transcript to respective corresponding media data portions; and
assembling a plurality of the media data portions to produce a resulting work, the media data portions corresponding to respective selected transcript portions.

12. The method of claim 11, further comprising displaying the working transcript to a user and enabling user selection of the selected transcript portion, said user selection determining the selected transcript portions.

13. The method of claim 11, further comprising producing a text script of the resulting work.

14. The method of claim 13, further comprising:
enabling a user to select a subset of statements in the text script; and
calculating an estimate of a place of occurrence in the media data corresponding to the user selected subset of statements.

15. The method of claim 14, further comprising displaying the estimate in a manner enabling a user to cross reference between a beginning and ending of the subset of statements and the corresponding media data.

16. The method of claim 15, further comprising enabling a user to (i) select a location of the resulting work to determine a corresponding location of the text script, and (ii) select a location of the text script to determine a corresponding location of the resulting work.

17. The method of claim 15, further comprising:
tracking user adjustment of the cross reference between the selected transcript portion and the corresponding media data;
calculating difference between the user adjustment and the calculated estimate; and
using the calculated difference in subsequent estimates in a manner that automates self-improved accuracy.

18. A computer-implemented system for editing media, comprising:
a transcription module that generates a working transcript of audio data of a subject media data;
an assembly module that, responsive to user selection of portions of the working transcript, (i) obtains portions of the media data corresponding to the portions of the working transcript, (ii) combines the media data portions to form a resulting work, and (iii) produces a text script of the resulting work.

19. The system of claim 18, further comprising a processor routine for (i) enabling a user to select a subset of statements in the text script, and (ii) calculating an estimate of a place of occurrence in the media data corresponding to the user selected subset of statements.

20. The system of claim 19, wherein the processor routine is responsive to user adjustment of a cross reference between a beginning and ending of the subset of statements and the corresponding media data, the processor routine:
tracking user adjustment of the cross reference between the selected transcript portion and the corresponding media data;
calculating difference between the user adjustment and the calculated estimate; and
using the calculated difference in subsequent estimates in a manner that automates self-improved accuracy.

21. In a network of computers formed of a host computer and a plurality of user computers coupled for communication with the host computer, a method of editing media comprising the steps of:
receiving a subject media data at the host computer, the media data including corresponding audio data;
transcribing the received subject media data to form a working transcript of the corresponding audio data;
associating portions of the working transcript to respective corresponding portions of the subject media data;
displaying the working transcript to a user and enabling user selection of portions of the subject media data through the displayed working transcript, said user selection including sequencing of portions of the subject media data;
for each user selected transcript portion from the displayed working transcript, calculating for display an estimated place of occurrence in the media data of the audio data corresponding to the user-selected transcript portion;
displaying the calculated estimated place of occurrence in a manner enabling a user to cross reference between a beginning and ending of the user-selected transcript portion and the corresponding media data;
tracking user adjustment of the cross reference between the user-selected transcript portion and the corresponding media data;
calculating difference between the user adjustment and the calculated estimate; and
using the calculated difference in subsequent estimates in a manner that automates self-improved accuracy.

22. The method of claim 22 further comprising, for each user-selected transcript portion, in real time, (i) obtaining the respective corresponding media data portion and (ii) combining the obtained media data portions to form a rough cut and succeeding cuts, the resulting rough cut and succeeding cuts having respective corresponding text scripts; and (iii) displaying the rough cut and succeeding cuts to the user during user interaction with the displayed working transcript; and
for each user selected segment from the displayed rough cut or succeeding cuts, in real time (i) obtaining the respective corresponding portions of the working transcript, (ii) combining the obtained transcript portions to form a resulting text script, and (iii) displaying the resulting text script to the user.
